(19) United States
(12) Patent Application Publication
(10) Pub. No.: US 2011/0004915 A1
(43) Pub. Date: Jan. 6, 2011

(54) METHOD AND APPARATUS FOR MANAGING ACCESS TO IDENTITY INFORMATION

(75) Inventors: Ilkka Antero Oksanen, Tampere (FI); Toni Juhani Paila, Koisjarvi (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 12/497,455

(22) Filed: Jul. 2, 2009

(51) Int. Cl. G06F 21/00; G06F 17/30

(52) U.S. Cl. 726/1; 707/791; 707/802; 707/803; 707/812

(57) ABSTRACT

Various methods for managing access to identity information are provided. One example method includes accessing media content received via a broadcast. The media content may be formatted such that a presentation of the media content is adaptable based at least in part on user identity information. The example method may also include determining whether the user identity information is accessible for retrieval based at least in part on an access control rule. Similar and related example methods and example apparatuses are also provided.

### TECHNICAL FIELD

Embodiments of the present invention relate generally to data security, and, more particularly, relate to a method and apparatus for managing access to identity information.

### BACKGROUND

The modern communications era has brought about a tremendous expansion of wireline and wireless networks. Various types of networking technologies have been developed resulting in an unprecedented expansion of computer networks, television networks, telephony networks, and the like, fueled by consumer demand. Wireless and mobile networking technologies have addressed related consumer demands, while providing more flexibility and immediacy of information transfer.

Evolving networking technologies continue to facilitate ease of information transfer and convenience to users by expanding the capabilities of mobile electronic devices and other computing devices. As the functionality of mobile communications devices has expanded, mobile communications devices have become ubiquitous in both business and personal settings and users continue to demand more functionality that allows users to quickly find and interact with more data in unique ways.

### BRIEF SUMMARY

Example methods and example apparatuses are described that provide for managing access to identity information, which may also be referred to as identity attributes. According to example embodiments of the present invention, user equipment (UE) may be configured to receive, via a broadcast, and access media content. The media content may be formatted in accordance with Rich Media Services (RMS). The UEs may be configured to adapt the presentation of the media content based on various attributes, such as user identity attributes stored on the UE. Since user identity attributes may include private information about a user, access control rules are checked prior to retrieving the user identity attributes. In the event that the access control rules prevent access to the user identity attributes, an error message may be generated, and presentation of the media content may be affected by the lack of the requested user identity attribute (e.g., the media may not be presented if the age of the user is undetermined). However, if, based on the access control rules, the user identity attribute is accessible, presentation of the media content may be accordingly altered based on the user identity attribute.

Various example embodiments of the present invention are described herein. One example embodiment is a method for managing access to identity information. The example method includes accessing media content received via a broadcast. The media content may be formatted such that a presentation of the media content is adaptable based at least in part on user identity information. The example method also includes determining whether the user identity information is accessible for retrieval based at least in part on an access control rule.

Another example embodiment is a method for managing access to identity information. The example method includes accessing media content. The media content may be formatted such that a presentation of the media content is adaptable based at least in part on user identity information. The user identity information may be accessible to a presenting device based at least in part on an access control rule. The example method may also include providing for a broadcast of media content to the presenting device.

An additional example embodiment is an apparatus for managing access to identity information. The example apparatus comprises at least one processor and at least one memory including computer program code. The at least one memory and the computer program code are configured to, with the at least one processor, cause the example apparatus to perform various functionality. In this regard, the example apparatus is caused to perform accessing media content received via a broadcast. The media content may be formatted such that a presentation of the media content is adaptable based at least in part on user identity information. The apparatus may also be caused to perform determining whether the user identity information is accessible for retrieval based at least in part on an access control rule.

An additional example embodiment is an apparatus for managing access to identity information. The example apparatus comprises at least one processor and at least one memory including computer program code. The at least one memory and the computer program code may be configured to, with the at least one processor, cause the example apparatus to perform various functionality. In this regard, the example apparatus is caused to perform accessing media content. The media content may be formatted such that a presentation of the media content is adaptable based at least in part on user identity information. The user identity information may be accessible to a presenting device based at least in part on an access control rule. The apparatus may also be caused to perform providing for a broadcast of media content to the presenting device.

Another example embodiment is an example computer program product for managing access to identity information. The example computer program product comprises at least one computer-readable storage medium having executable computer-readable program code instructions stored therein. The computer-readable program code instructions of the example computer program product are for causing an apparatus to perform accessing media content received via a broadcast. The media content may be formatted such that a presentation of the media content is adaptable based at least in part on user identity information. The computer-readable program code instructions are also for causing the apparatus to perform determining whether the user identity information is accessible for retrieval based at least in part on an access control rule.

Another example embodiment is an example computer program product for managing access to identity information. The example computer program product comprises at least one computer-readable storage medium having executable computer-readable program code instructions stored therein. The computer-readable program code instructions of the example computer program product are for causing an apparatus to perform accessing media content. The media content may be formatted such that a presentation of the media content is adaptable based at least in part on user identity information. The user identity information may be accessible to a presenting device based at least in part on an access control rule. The computer-readable program code instructions are also for causing the apparatus to perform providing for a broadcast of media content to the presenting device.

Another example embodiment is an apparatus for managing access to identity information. The example apparatus includes means for accessing media content received via a broadcast. The media content may be formatted such that a presentation of the media content is adaptable based at least in part on user identity information. The example apparatus also includes means for determining whether the user identity information is accessible for retrieval based at least in part on an access control rule.

Another example embodiment is an apparatus for managing access to identity information. The example apparatus includes means for accessing media content. The media content may be formatted such that a presentation of the media content is adaptable based at least in part on user identity information. The user identity information may be accessible to a presenting device based at least in part on an access control rule. The example apparatus also includes means for providing for a broadcast of media content to the presenting device.

### BRIEF DESCRIPTION OF THE DRAWING(S)

Having thus described the invention in general terms, reference will now be made to the accompanying drawings, which are not necessarily drawn to scale, and wherein:

FIG. 1 illustrates an communications system for managing access to identity attributes according to an example embodiment of the present invention;

FIG. 2 is a block diagram depicting an identity information function call according to an example embodiment of the present invention;

FIG. 3 illustrates a device management access control subtree according to an example embodiment of the present invention;

FIG. 4 is a flow chart of an example method for managing access to identity attributes according to an example embodiment of the present invention;

FIG. 5 illustrates example script code for an identity information function call according to an example embodiment of the present invention;

FIG. 6 is a block diagram of an apparatus for managing access to identity attributes according to an example embodiment of the present invention;

FIG. 7 is a block diagram of a mobile terminal for managing access to identity attributes according to an example embodiment of the present invention;

FIG. 8 illustrates block diagram another example apparatus for managing access to identity attributes according to an example embodiment of the present invention;

FIG. 9 is a flow chart illustrating a method for managing access to identity attributes according to an example embodiment of the present invention; and

FIG. 10 is a flow chart illustrating another method for managing access to identity attributes according to an example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

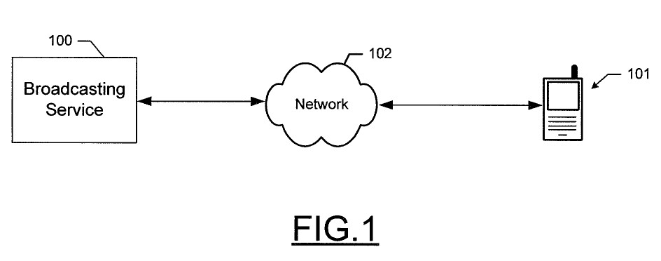

FIG. 1 depicts a communications system according to an example embodiment of the present invention. The example system includes a broadcasting service 100, user equipment (UE) 101, and a network 102. The broadcasting service 100 may be a server or other computing and communications device configured to broadcast media content via the network 102. According to one example embodiment, the broadcasting service 100 is configured to broadcast rich media content, where according to one example embodiment, the rich media content is formatted in accordance with Rich Media Services (RMS). In this regard, rich media content is a type of media content. Further, the broadcasting service 100 and the UE 101 may be configured to support Open Mobile Alliance (OMA) Mobile Broadcast Services Enabler Suite (BCAST).

The network 102 may be any type of wireless communications network that supports communications between the broadcasting service 100 and the UE 101. The UE 101 may be a mobile or stationary communications device configured to receive and act upon communications received via the network 102. In one example embodiment, the UE 101 is a mobile terminal. According to one example embodiment, the UE 101 is configured to receive media content broadcasted by the broadcasting service 100.

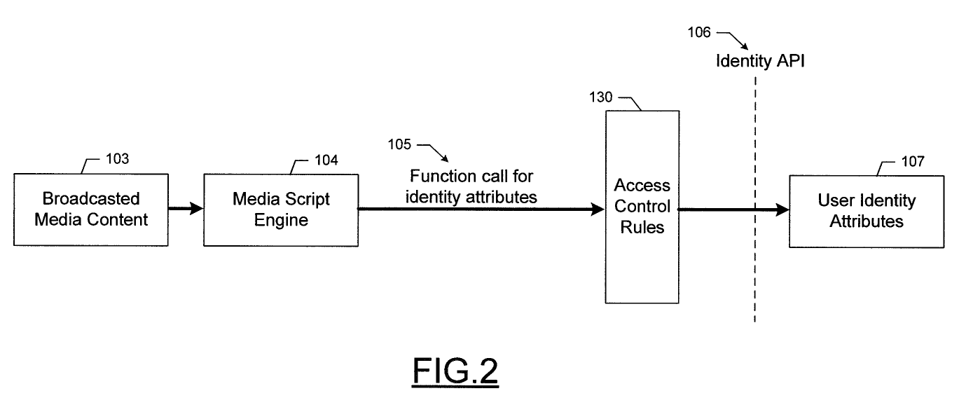

FIG. 2 depicts a flow chart describing example operations that a UE 101 may execute in response to receiving broadcasted media content from the broadcasting service 100. At 103, the UE 101 receives the broadcasted media content (e.g., rich media content) in the form of, for example an advertisement. At 104, the UE 101 implements a media script engine to retrieve information for facilitating an altered presentation of the received media content. In one example embodiment, the media script engine is a software application. The media script engine may execute a script that is provided with the media content. The media script engine, at 105, makes one or more function calls for identity attributes. Use of the media script engine supports the ability of a content provider (e.g., broadcast service 100) to broadcast the same media content to a plurality of UEs, and subsequently provide for adapting presentations of the media content based on various attributes (e.g., user identity attributes) at runtime.

According to one example embodiment, the function calls are performed in consideration of access control rules 130. In this regard, the media script engine may interface with a device management data structure to check the access control rules for each of the function calls. The access control rules 103 may operate as a filter to the function calls to prevent particular information from being retrieved by the media script engine 104 from a memory device within the UE or elsewhere. In this regard, a user or manufacturer may define the access control rules 130 to protect the privacy of particular information, such as user identity attributes 107. User identity attributes may include a user's name, age, gender, mailing address, email address, residence, home/work/mobile phone numbers, personal webpage address, location information such as the user's current or past location, information about the user's contacts, behavioral information (e.g., what websites the user frequents) that has been captured by the UE, or the like. In a similar regard, the media script engine may also operate with respect to device identity attributes, such as a device address or other unique identifier. While many of the example embodiments described herein operate with respect to user identity attributes, example embodiments of the present invention are equally applicable to device identity attributes.

The access control rules 130 may be configured to provide various and dynamic levels of security with respect to various types of user identity attributes. For example, an access control rule for the user's phone number may be set to a “reject” policy. Accordingly, a function call for the user's phone number may be blocked and an error message may be provided due the policy of the access control rule. However, an access control rule for the user's age may be set to an “allow” policy. Accordingly, a function call for the user's age may be granted access by the access control rule, and the identity Application Programming Interface (API) 106 may return a value for the user's age from the user identity attributes 107. According to one example embodiment, upon retrieving a user identity attribute, the media script engine may be configured to provide for transmission of the user identity attribute to a network entity, such as the broadcasting service 100. In this manner, advertisers may compile user identity attributes that users have allowed to be retrieved.

The UE may subsequently process and present an adapted version of the media content based on the user's age and/or based on the inability to retrieve the user's phone number. Processing the media content may include blocking the presentation of the media content, selecting from a set of media content options, or augmenting the media content (e.g., blurring areas of video, bleeping particular words, or the like). In this regard, the adapted presentation may be age appropriate (e.g., limited graphic content, advertisements geared toward an age group, etc.). The media content, which may be rich media content, may be formatted to facilitate interactive and dynamic presentations of the content using, for example, vector graphics and scripting languages, such as Javascript. In this way, interactive advertisements, dynamic service guides, voting, and the like, may be implemented via the content. According to one example embodiment, adapting the presentation of media content based on the user identity attributes may include blocking presentation of the media content. According to one example embodiment of the present invention, media content may be broadcast in the form of an advertisement. In this regard, the user identity information may be used to process the media content. For example, the media content may be a survey for a product or a line of products. If the product or line of products are typically used by, for example, women, user identity information indicating a user is a woman may be used for processing and adapting the content. In this regard, if the user is a woman, the media content may be presented to the user and the user may be allowed to interact with the content to complete the survey. However, if the user is not a woman, the content may be blocked, or selected content for men may be provided.

The access control rules may be user, manufacturer, or network provider configured to increase the security or decrease the security with respect to user identity attributes. A user, manufacturer, or network provider may also disable modification of the access control rules, for example, to prevent minors altering or modifying the access control rules, and thereby preventing exposure to particular types or formats of media content. Further, in one example embodiment, access control rules may be configured based on local regulations and privacy laws, or contractual agreements between a user and a network operator.

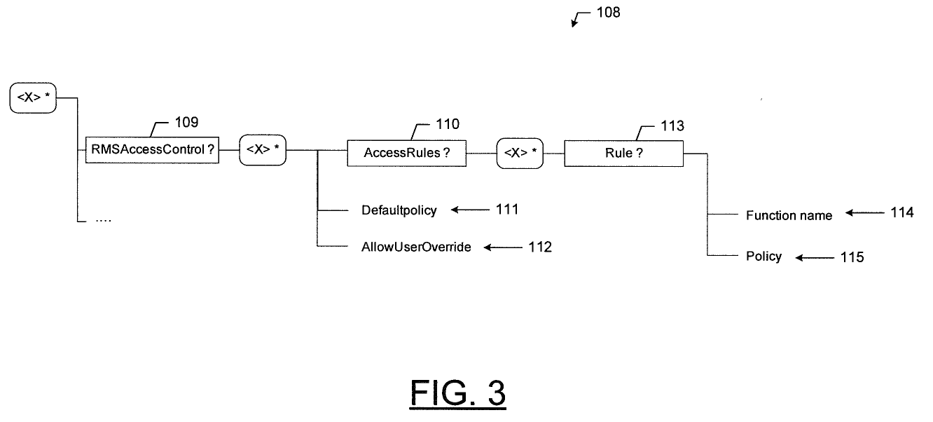

According to one example embodiment, the access control rules may be included in a device management object data structure. The device management object data structure may be in the form of a tree structure. In this regard, the device management tree structure may comprise one of a device management object, a device management subtree, or a device management access control subtree. According to one example embodiment, the access control rules may be included in a subtree of a device management tree. FIG. 3 depicts an example access control subtree 108. RMSAccessControl 109 may be a root node for the access control subtree 108. In this regard, the RMSAccessControl 109 may separate access control parameters from other parameters, such as OMA BCAST mobile television parameters. The DefaultPolicy 111 may be a setting that is utilized when no matching rules for a particular identity attribute have been defined. For example, if the DefaultPolicy 111 is set to “prompt user,” each time a function call for an identity attribute that does not have a specific access control rule is performed, a prompt to the user may be provided due to the default policy. Possible example values for DefaultPolicy 111 include “allow,” “prompt user,” and “reject.” AllowUserOverride 112 indicates whether a user, manufacturer, or network provider is permitted to alter the access control rules. Possible example values for AllowUserOverride 112 may be “true,” or “false.” AccessRules 110 is a placeholder separating a list of specific rules within the subtree. Rule 113 may be a subnode that separates instructions regarding how to handle a function call for an identity attribute (e.g., age, gender, phone number, etc.) via the identity API. Function name 114 may be the name of a function that is affected by the rule (e.g., identity.getAge(), identity.getGender(), identity.getPhoneNo(), etc.). Policy 115 may indicate the policy for the function. In this regard, possible example values for Policy 115 include “allow,” “prompt user,” and “reject.”

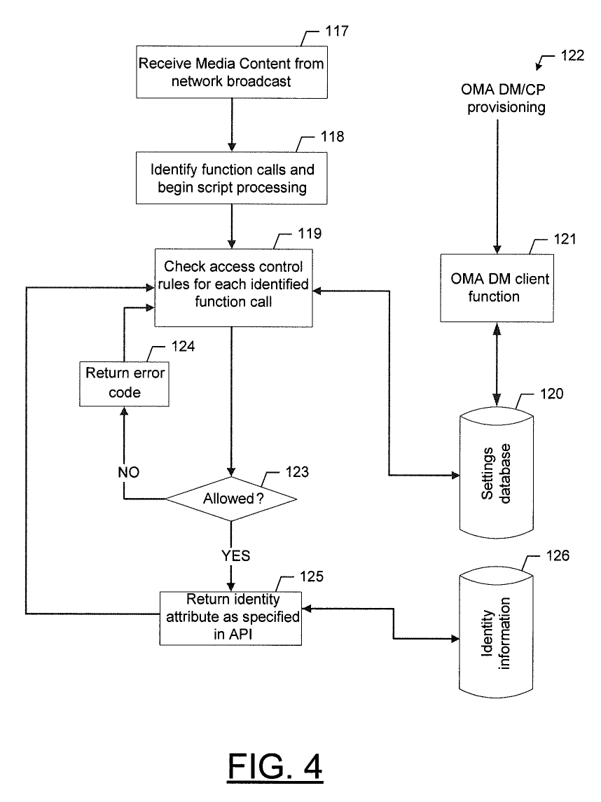

FIG. 4 illustrates another example method according to an example embodiment of the present invention. The example method of FIG. 4 may be performed by a UE, such as UE 101. At 117, media content may be received via a network broadcast. Subsequent to receipt, at 118, the media content may be analyzed to identify function calls and script processing of the function calls may begin. The access control rules may be checked via scripting for each identified function call at 119. For function calls that do not have specific access control rules, a default policy may be checked. To access the access control rules, a processor implementing a script may check with a setting database 120 which may be provided via an OMA device management client function 121. The OMA device management client function may be supported by OMA device management and client provisioning at 122.

Based on the access control rules, at 123, a determination may be made as to whether the function call is allowed to return a value. If a function call is rejected, an error code may be returned at 124 and the next function call may be considered at 119. If a function call is allowed, an identity attribute may be retrieved from the identity information 126 and returned via an identity API. Upon returning the identity attribute, the next function call may be considered at 119.

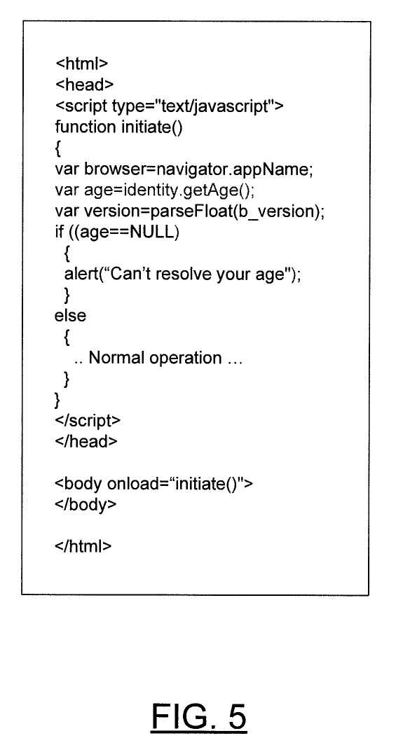

FIG. 5 illustrates an example script (e.g., Javascript) with a function call for a user identity attribute. The user identity attribute is an age attribute. The script may fetch an associated access control rule for the age attribute and determine whether the function call identity.getAge() is allowed access or rejected access based on the access control rule. If the access control rule rejects access to the age attribute, NULL is returned and an alert is provided indicating that the user's age cannot be resolved. If the access control rule allows access to the age attribute normal operations may be implemented and the age attribute may be fetched from the identity information storage.

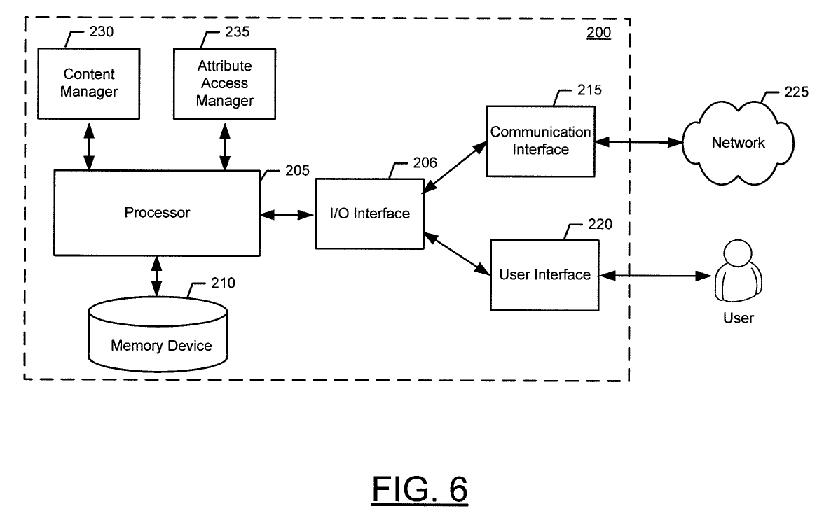

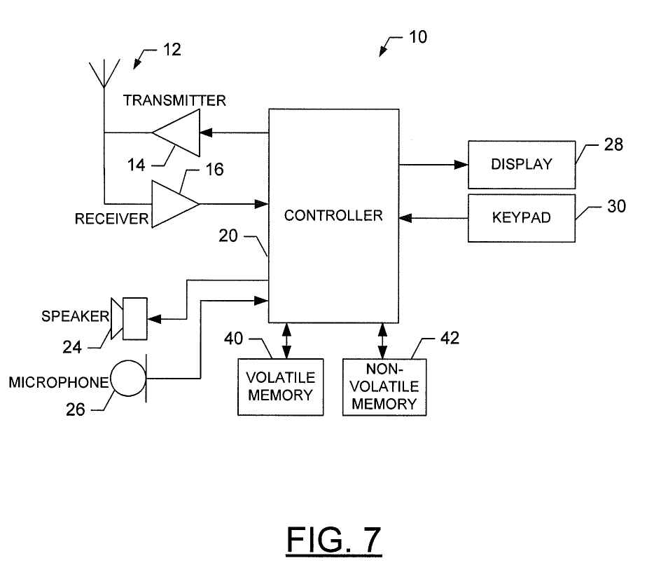

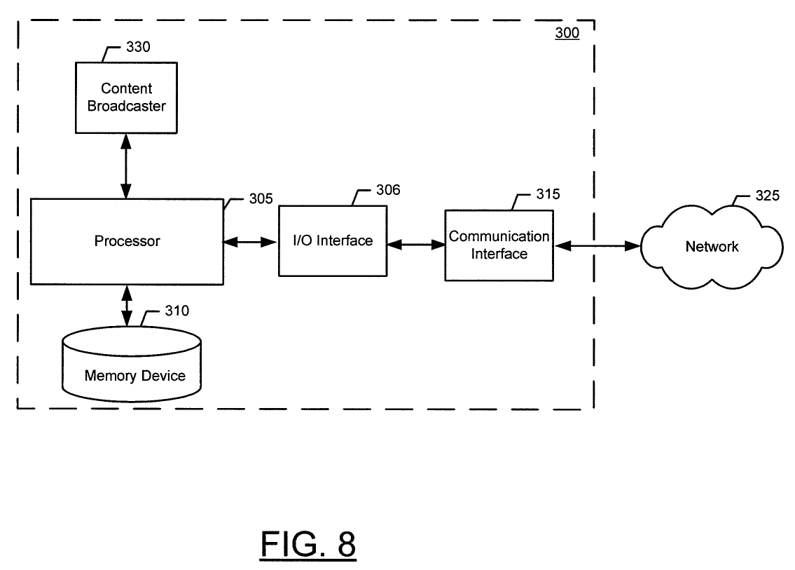

The description provided above and generally herein illustrates example methods, example apparatuses, and example computer program products for managing access to identity attributes. FIGS. 6-8 illustrate example apparatus embodiments of the present invention configured to perform the various functionalities described herein. FIG. 6 depicts an example apparatus that is configured to perform various functionalities from the perspective of a UE (e.g., UEs 101) as described with respect to FIG. 1 and as generally described herein. FIG. 7 depicts an example UE apparatus in the form of a mobile terminal configured to perform various functionalities from the perspective of a UE 101 depicted in FIG. 1 and as generally described herein. FIG. 8 depicts an example apparatus that is configured to perform various functionalities from the perspective of a service (e.g., broadcasting service 100) as described with respect to FIG. 1 and as generally described herein. The example apparatuses depicted in FIGS. 6-8 may also be configured to perform example methods of the present invention, such as those described with respect to FIGS. 2, 4, 9, and 10.

Referring now to FIG. 6, in some example embodiments, the apparatus 200 may, be embodied as, or included as a component of, a communications device with wired or wireless communications capabilities. In this regard, the apparatus 200 may be configured to operate in accordance with the functionality of a UE as described herein. In some example embodiments, the apparatus 200 may be part of a communications device (e.g., UE 101), such as a stationary or a mobile terminal. As a stationary terminal, the apparatus 200 may be part of an access point (e.g., a base station, wireless router, or the like), a computer, a server, a device that supports network communications, or the like. As a mobile terminal, the apparatus 200 may be a mobile computer, mobile telephone, a portable digital assistant (PDA), a pager, a mobile television, a gaming device, a mobile computer, a laptop computer, a camera, a video recorder, an audio/video player, a radio, and/or a global positioning system (GPS) device, any combination of the aforementioned, or the like. Regardless of the type of communications device, apparatus 200 may also include computing capabilities.

The example apparatus 200 includes or is otherwise in communication with a processor 205, a memory device 210, an Input/Output (I/O) interface 206, a communications interface 215, user interface 220, a content manager 230, and an attribute access manager 235. The processor 205 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 205 may be representative of a plurality of processors, or one or more multiple core processors, operating in concert. Further, the processor 205 may be comprised of a plurality of transistors, logic gates, a clock (e.g., oscillator), other circuitry, and the like to facilitate performance of the functionality described herein. The processor 205 may, but need not, include one or more accompanying digital signal processors. In some example embodiments, the processor 205 is configured to execute instructions stored in the memory device 210 or instructions otherwise accessible to the processor 205. The processor 205 may be configured to operate such that the processor causes the apparatus 200 to perform various functionalities described herein.

Whether configured as hardware or via instructions stored on a computer-readable storage medium, or by a combination thereof, the processor 205 may be an entity capable of performing operations according to embodiments of the present invention while configured accordingly. Thus, in example embodiments where the processor 205 is embodied as, or is part of, an ASIC, FPGA, or the like, the processor 205 is specifically configured hardware for conducting the operations described herein. Alternatively, in example embodiments where the processor 205 is embodied as an executor of instructions stored on a computer-readable storage medium, the instructions specifically configure the processor 205 to perform the algorithms and operations described herein. In some example embodiments, the processor 205 is a processor of a specific device (e.g., a mobile terminal) configured for employing example embodiments of the present invention by further configuration of the processor 205 via executed instructions for performing the algorithms, methods, and operations described herein.

The memory device 210 may be one or more computer-readable storage media that may include volatile and/or non-volatile memory. In some example embodiments, the memory device 210 includes Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, and/or the like for enabling the processor 205 and the example apparatus 200 to carry out various functions in accordance with example embodiments of the present invention described herein. For example, the memory device 210 could be configured to buffer input data for processing by the processor 205. Additionally, or alternatively, the memory device 210 may be configured to store instructions for execution by the processor 205.

The I/O interface 206 may be any device, circuitry, or means embodied in hardware, software, or a combination of hardware and software that is configured to interface the processor 205 with other circuitry or devices, such as the communications interface 220 and the user interface 215. In some example embodiments, the processor 205 may interface with the memory 210 via the I/O interface 206. The I/O interface 206 may be configured to convert signals and data into a form that may be interpreted by the processor 205. The I/O interface 206 may also perform buffering of inputs and outputs to support the operation of the processor 205. According to some example embodiments, the processor 205 and the I/O interface 206 may be combined onto a single chip or integrated circuit configured to perform, or cause the apparatus 200 to perform, various functionalities of the present invention. The communication interface 215 may be any device or means embodied in either hardware, a computer program product, or a combination of hardware and a computer program product that is configured to receive and/or transmit data from/to a network 225 and/or any other device or module in communication with the example apparatus 200. Processor 205 may also be configured to facilitate communications via the communications interface by, for example, controlling hardware included within the communications interface 215. In this regard, the communication interface 215 may include, for example, one or more antennas, a transmitter, a receiver, a transceiver and/or supporting hardware, including, for example, a processor for enabling communications. Via the communication interface 215, the example apparatus 200 may communicate with various other network entities in a device-to-device fashion and/or via indirect communications via a base station, access point, server, gateway, router, or the like.

The communications interface 215 may be configured to provide for communications in accordance with any wired or wireless communication standard. The communications interface 215 may be configured to support communications in multiple antenna environments, such as multiple input multiple output (MIMO) environments. Further, the communications interface 215 may be configured to support orthogonal frequency division multiplexed (OFDM) signaling. In some example embodiments, the communications interface 215 may be configured to communicate in accordance with various techniques, such as, second-generation (2G) wireless communication protocols, IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 215 may also be configured to support communications at the network layer, possibly via Internet Protocol (IP).

The user interface 220 may be in communication with the processor 205 to receive user input via the user interface 220 and/or to present output to a user as, for example, audible, visual, mechanical or other output indications. The user interface 220 may include, for example, a keyboard, a mouse, a joystick, a display (e.g., a touch screen display), a microphone, a speaker, or other input/output mechanisms. According to various example embodiments, the user interface 220 may include hardware and/or software to support the operation of an image capturing device, such as a camera module. The image capturing device may be configured to capture images that may be acted upon in accordance with example embodiments of the present invention.

The content manager 230 and/or the attribute access manager 235 of example apparatus 200 may be any means or device embodied, partially or wholly, in hardware, a computer program product, or a combination of hardware and a computer program product, such as processor 205 implementing stored instructions to configure the example apparatus 200, or a hardware configured processor 205, that is configured to carry out the functions of the content manager 230 and/or the attribute access manager 235 as described herein. In an example embodiment, the processor 205 includes, or controls, the content manager 230 and/or the attribute access manager 235. The content manager 230 and/or the attribute access manager 235 may be, partially or wholly, embodied as processors similar to, but separate from processor 205. In this regard, the content manager 230 and/or the attribute access manager 235 may be in communication with the processor 205. In various example embodiments, the content manager 230 and/or the attribute access manager 235 may, partially or wholly, reside on differing apparatuses such that some or all of the functionality of the content manager 230 and/or the attribute access manager 235 may be performed by a first apparatus, and the remainder of the functionality of the content manager 230 and/or the attribute access manager 235 may be performed by one or more other apparatuses.

The apparatus 200 and the processor 205 may be configured to perform the following functionality via the content manager 230. In this regard, the content manager 230 is configured to access media content received via a broadcast. For example, the media content may be accessed from the memory device 210 or directly from the communications interface 215, from which the broadcast was received. The media content may be formatted such that a presentation of the media content (e.g., on the user interface 220) is adaptable based at least in part on a user identity attribute. User identity attributes may be stored in the memory device 210. According to various example embodiments, the content manager 230 is further configured to provide for a presentation of the media content via, for example, the user interface 220. In this regard, the content manager 210 may be configured to adapt the presentation of the media content based on user identity attributes.

The apparatus 200 and the processor 205 may be configured to perform the following functionality via the attribute access manager 235. In this regard, according to various example embodiments, the attribute access manager 235 is configured to determine whether the user identity attribute is accessible for retrieval based at least in part on an access control rule. One or more access control rules may be stored in the memory device 210, and the access control rules are therefore accessible to the attribute access manager 235 from the memory device 210. The attribute access manager 235 may be configured to retrieve the user identity attribute in response to determining that the user identify attribute is accessible based at least in part on the access control rule. According to various example embodiments, the attribute access manager 235 implements a media script engine. The media script engine may be configured to determine whether the user identity attribute is accessible and retrieve, or call for the retrieval of, the user identity attribute in response to determining that the user identity attribute is accessible based on the access control rule. According to various example embodiments, the access control rule is included in a device management object data structure. In some example embodiments, the device management object data structure is a tree structure and the access control rule may be included in an access control subtree of a device management object data structure. Further, in some example embodiments, upon determining that the user identity attribute is accessible and retrieving the user identity attribute, the attribute access manager 235 is configured to provide for transmission of the user identity attribute to an entity associated with the media content.

Referring now to FIG. 7, a more specific example apparatus in accordance with various embodiments of the present invention is provided. The example apparatus of FIG. 3 is a mobile terminal 10 configured to communicate within a wireless network, such as a cellular communications network. The mobile terminal 10 may be configured to perform the functionality of UE 101 and/or apparatus 200 as described herein. More specifically, the mobile terminal 10 may be caused to perform the functionality of the content manager 230 and/or the attribute access manager 235 via the controller 20. In this regard, controller 20 may be an integrated circuit or chip configured similar to the processor 205 together with the I/O interface 206. Further, volatile memory 40 and non-volatile memory 42 may be configured to support the operation of the controller 20 as computer readable storage media.

The mobile terminal 10 may further include an antenna 12, a transmitter 14, and a receiver 16, which may be included as parts of a communications interface of the mobile terminal 10. The speaker 24, the microphone 26, the display 28, and the keypad 30 may be included as parts of a user interface.

Referring now to FIG. 8, in some example embodiments, the apparatus 300 may, be embodied as, or included as a component of, a communications device with wired or wireless communications capabilities. In this regard, the apparatus 300 may be configured to operate in accordance with the functionality of a broadcasting service as described herein. In some example embodiments, the apparatus 300 may part of a communications device (e.g., broadcasting service 100), such as a stationary or a mobile terminal. As a stationary terminal, the apparatus 300 may be part of an access point (e.g., a base station, wireless router, or the like), a computer, a server, a device that supports network communications, or the like. As a mobile terminal, the apparatus 300 may be a mobile computer, mobile telephone, a portable digital assistant (PDA), a pager, a mobile television, a gaming device, a mobile computer, a laptop computer, a camera, a video recorder, an audio/video player, a radio, and/or a global positioning system (GPS) device, any combination of the aforementioned, or the like. Regardless of the type of communications device, apparatus 300 may also include computing capabilities.

The example apparatus 300 includes or is otherwise in communication with a processor 305, a memory device 310, an Input/Output (I/O) interface 306, a communications interface 315, and a content broadcaster 330. The processor 305 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 305 may be representative of a plurality of processors, or one or more multiple core processors, operating in concert. Further, the processor 305 may be comprised of a plurality of transistors, logic gates, a clock (e.g., oscillator), other circuitry, and the like to facilitate performance of the functionality described herein. The processor 305 may, but need not, include one or more accompanying digital signal processors. In some example embodiments, the processor 305 is configured to execute instructions stored in the memory device 310 or instructions otherwise accessible to the processor 305. The processor 305 may be configured to operate such that the processor causes the apparatus 300 to perform various functionalities described herein.

Whether configured as hardware or via instructions stored on a computer-readable storage medium, or by a combination thereof, the processor 305 may be an entity capable of performing operations according to embodiments of the present invention while configured accordingly. Thus, in example embodiments where the processor 305 is embodied as, or is part of, an ASIC, FPGA, or the like, the processor 305 is specifically configured hardware for conducting the operations described herein. Alternatively, in example embodiments where the processor 305 is embodied as an executor of instructions stored on a computer-readable storage medium, the instructions specifically configure the processor 305 to perform the algorithms and operations described herein. In some example embodiments, the processor 305 is a processor of a specific device (e.g., a mobile terminal) configured for employing example embodiments of the present invention by further configuration of the processor 305 via executed instructions for performing the algorithms, methods, and operations described herein.

The memory device 310 may be one or more computer-readable storage media that may include volatile and/or non-volatile memory. In some example embodiments, the memory device 310 includes Random Access Memory (RAM) including dynamic and/or static RAM, on-chip or off-chip cache memory, and/or the like. Further, memory device 310 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 310 may include a cache area for temporary storage of data. In this regard, some or all of memory device 310 may be included within the processor 305.

Further, the memory device 310 may be configured to store information, data, applications, computer-readable program code instructions, and/or the like for enabling the processor 305 and the example apparatus 300 to carry out various functions in accordance with example embodiments of the present invention described herein. For example, the memory device 310 could be configured to buffer input data for processing by the processor 305. Additionally, or alternatively, the memory device 310 may be configured to store instructions for execution by the processor 305.

The I/O interface 306 may be any device, circuitry, or means embodied in hardware, software, or a combination of hardware and software that is configured to interface the processor 305 with other circuitry or devices, such as the communications interface 315. In some example embodiments, the processor 305 may interface with the memory 310 via the I/O interface 306. The I/O interface 306 may be configured to convert signals and data into a form that may be interpreted by the processor 305. The I/O interface 306 may also perform buffering of inputs and outputs to support the operation of the processor 305. According to some example embodiments, the processor 305 and the I/O interface 306 may be combined onto a single chip or integrated circuit configured to perform, or cause the apparatus 300 to perform, various functionalities of the present invention.

The communication interface 315 may be any device or means embodied in either hardware, a computer program product, or a combination of hardware and a computer program product that is configured to receive and/or transmit data from/to a network 325 and/or any other device or module in communication with the example apparatus 300. Processor 305 may also be configured to facilitate communications via the communications interface by, for example, controlling hardware included within the communications interface 315. In this regard, the communication interface 315 may include, for example, one or more antennas, a transmitter, a receiver, a transceiver and/or supporting hardware, including, for example, a processor for enabling communications. Via the communication interface 315, the example apparatus 300 may communicate with various other network entities in a device-to-device fashion and/or via indirect communications via a base station, access point, server, gateway, router, or the like.

The communications interface 315 may also include power control logic for powering down unneeded radios, modem components, and the like, when the apparatus 300 enters a sleep or idle mode. In this regard, the processor 305 may be configured to control the power control logic to initiate an activate mode to support data transfers, and return to a sleep mode when data transfers are complete.

The communications interface 315 may be configured to provide for communications in accordance with any wired or wireless communication standard. The communications interface 315 may be configured to support communications in multiple antenna environments, such as multiple input multiple output (MIMO) environments. Further, the communications interface 315 may be configured to support orthogonal frequency division multiplexed (OFDM) signaling. In some example embodiments, the communications interface 315 may be configured to communicate in accordance with various techniques, such as, second-generation (2G) wireless communication protocols, IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 315 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 315 may also be configured to support communications at the network layer, possibly via Internet Protocol (IP).

The content broadcaster 330 of example apparatus 300 may be any means or device embodied, partially or wholly, in hardware, a computer program product, or a combination of hardware and a computer program product, such as processor 305 implementing stored instructions to configure the example apparatus 300, or a hardware configured processor 305, that is configured to carry out the functions of the content broadcaster 330 as described herein. In an example embodiment, the processor 305 includes, or controls, the content broadcaster 330. The content broadcaster 330 may be, partially or wholly, embodied as processors similar to, but separate from processor 305. In this regard, the content broadcaster 330 may be in communication with the processor 305. In various example embodiments, the content broadcaster 330 may, partially or wholly, reside on differing apparatuses such that some or all of the functionality of the content broadcaster 330 may be performed by a first apparatus, and the remainder of the functionality of the content broadcaster 330 may be performed by one or more other apparatuses.

The apparatus 300 and the processor 305 may be configured to perform the following functionality via the content broadcaster 330. In this regard, the content broadcaster 330 may be configured to access media content. The media content may be formatted such that a presentation of the media content is adaptable based at least in part on a user identity attribute. The user identity attribute may be accessible to a presenting apparatus based at least in part on an access control rule. The content broadcaster 330 may also be configured to provide for broadcasting the media content to the presenting device. Further, in some example embodiments, the content broadcaster 330 may be configured to access a received user identity attribute in response to a determination that the access control rule permits access to the user identity attribute. In this regard, the user identity attribute may have been received from a presenting apparatus.

FIGS. 2, 4, 9, and 10 illustrate flowcharts of example systems, methods, and/or computer program products according to example embodiments of the invention. It will be understood that each block or operation of the flowcharts, and/or combinations of blocks or operations in the flowcharts, can be implemented by various means. Means for implementing the blocks or operations of the flowcharts, combinations of the blocks or operations in the flowchart, or other functionality of example embodiments of the present invention described herein may include hardware, and/or a computer program product including a computer-readable storage medium having one or more computer program code instructions, program instructions, or executable computer-readable program code instructions stored therein. In this regard, program code instructions may be stored on a memory device, such as memory devices 210 or 310, of an example apparatus, such as example apparatuses 200 or 300, and executed by a processor, such as the processors 205 or 305. As will be appreciated, any such program code instructions may be loaded onto a computer or other programmable apparatus (e.g., processor 205, processor 305, memory device 210, memory device 310, or the like) from a computer-readable storage medium to produce a particular machine, such that the particular machine becomes a means for implementing the functions specified in the flowcharts' block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s) or operation(s).

Accordingly, execution of instructions associated with the blocks or operations of the flowchart by a processor, or storage of instructions associated with the blocks or operations of the flowcharts in a computer-readable storage medium, support combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions.

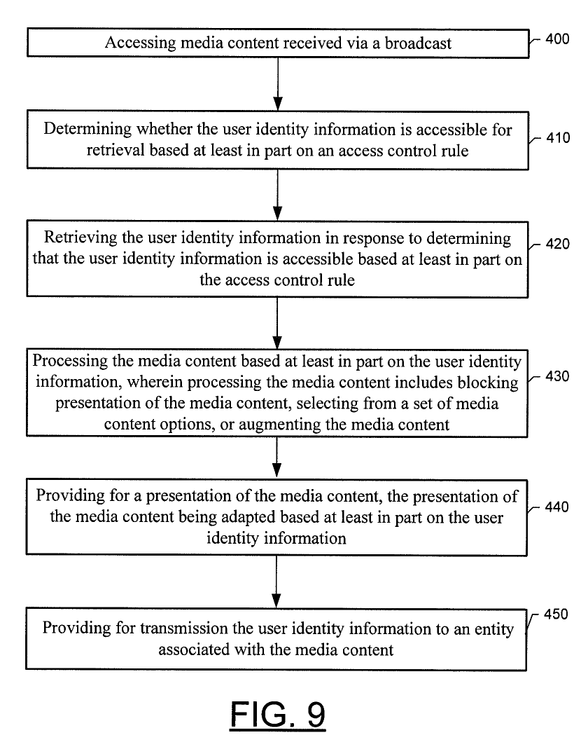

FIG. 9 depicts one or more flowcharts of example methods for managing access to identity attributes/information from the perspective of a UE (e.g., UEs 101). The example method includes accessing media content received via a broadcast at 400. The media content may be formatted such that a presentation of the media content is adaptable based at least in part on user identity information.

The example method of FIG. 9 also includes determining whether the user identity information is accessible for retrieval based at least in part on an access control rule at 410. At 420, the example method includes retrieving the user identity information in response to determining that the user identity information is accessible based at least in part on the access control rule. According to various example embodiments, determining whether the user identity information is accessible includes implementing a media script engine. The media script engine may be configured to determine whether the user identity information is accessible and retrieve, or call for the retrieval of, the user identity information in response to determining that the user identify information is accessible based on the access control rule. According to various example embodiments, the access control rule includes in a device management object data structure. In some example embodiments, the device management object data structure is a tree structure and the access control rule is included in an access control subtree of a device management object data structure.

According to various example embodiments, the example method further includes providing for a presentation of the media content at 430. In this regard, the media content may be adapted based on retrieved user identity information. Further, the example method includes, upon determining that the user identity information is accessible and retrieving the user identity information, providing for transmission of the user identity information to an entity associated with the media content at 440.

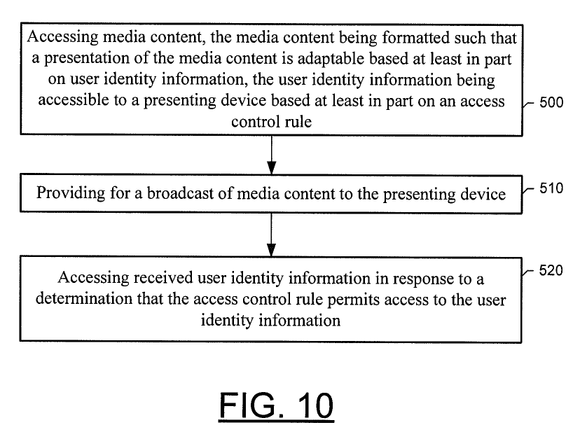

FIG. 10 depicts one or more flowcharts of example methods for managing access to identity attributes/information from the perspective of a service, such as the broadcasting service 100. The example method includes accessing media content at 500. The media content may be formatted such that a presentation of the media content is adaptable based at least in part on user identity information. The user identity information may be accessible to a presenting apparatus based at least in part on an access control rule. The example method also includes providing for broadcasting the media content to the presenting device at 510. Further, in some example embodiments, the example method may include accessing received user identity information in response to a determination that the access control rule permits access to the user identity information. In this regard, the user identity information may have been received from a presenting apparatus.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
accessing media content received via a broadcast, the media content being formatted such that a presentation of the media content is adaptable based at least in part on a user identity information; and
determining, via a processor, whether the user identity information is accessible for retrieval based at least in part on an access control rule.

2. The method of claim 1, wherein the access control rule is included in a device management data structure.

3. The method of claim 2, wherein device management data structure comprises one of a device management object, a device management subtree, or a device management access control subtree.

4. The method of claim 1 further comprising:
retrieving the user identity information in response to determining that the user identity information is accessible based at least in part on the access control rule; and
providing for a presentation of the media content, the presentation of the media content being adapted based at least in part on the user identity information.

5. The method of claim 1, wherein a media scrip engine is configured to determine whether the user identity information is accessible and to retrieve the user identity information in response to determining that the user identity information is accessible.

6. The method of claim 1, further comprising:
retrieving the user identity information in response to determining that the user identity information is accessible based at least in part on the access control rule; and
providing for transmission of the user identity information to an entity associated with the media content.

7. The method of claim 1, further comprising processing the media content based at least in part on the user identity information, wherein processing the media content comprises at least one of blocking presentation of the media content, selecting from a set of media content options, or augmenting the media content.

8. An apparatus comprising at least one processor and at least one memory including computer program code, the at least one memory and the computer program code configured to, with the at least one processor, cause the apparatus at least to perform:
accessing media content received via a broadcast, the media content being formatted such that a presentation of the media content is adaptable based at least in part on user identity information; and
determining whether the user identity information is accessible for retrieval based at least in part on an access control rule.

9. The apparatus of claim 8, wherein the access control rule is included in a device management data structure.

10. The apparatus of claim 9, wherein device management data structure comprises one of a device management object, a device management subtree, or a device management access control subtree.

11. The apparatus of claim 8, wherein the apparatus is further caused to perform:
retrieving the user identity information in response to determining that the user identity information is accessible based at least in part on the access control rule; and
providing for a presentation of the media content, the presentation of the media content being adapted based at least in part on the user identity information.

12. The apparatus of claim 8, wherein the apparatus includes a media script engine configured to determine whether the user identity information is accessible and to retrieve the user identity information in response to determining that the user identity information is accessible.

13. The apparatus of claim 8, wherein the apparatus is further caused to perform:
retrieving the user identity information in response to determining that the user identity information is accessible based at least in part on the access control rule; and
providing for transmission of the user identity information to an entity associated with the media content.

14. The apparatus of claim 8, wherein the apparatus is further caused to perform processing the media content based at least in part on the user identity information, wherein processing the media content comprises at least one of blocking presentation of the media content, selecting from a set of media content options, or augmenting the media content.

16. The apparatus of claim 8, wherein the apparatus comprises a mobile terminal.

17. A method comprising:
accessing media content, via a processor, the media content being formatted such that a presentation of the media content is adaptable based at least in part on user identity information, the user identity information being accessible to a presenting device based at least in part on an access control rule; and
providing for broadcasting the media content to the presenting device.

18. The method of claim 17 further comprising accessing a received user identity information in response to a determination that the access control rule permits access to the user identity information.

19. An apparatus comprising at least one processor and at least one memory including computer program code, the at least one memory and the computer program code configured to, with the at least one processor, cause the apparatus at least to perform:
accessing media content, the media content being formatted such that a presentation of the media content is adaptable based at least in part on user identity information, the user identity information being accessible to a presenting device based at least in part on an access control rule; and
providing for broadcasting the media content to the presenting device.

20. The apparatus of claim 19, wherein the apparatus is further caused to perform accessing a received user identity information in response to a determination that the access control rule permits access to the user identity information.
